(19) United States
(12) Patent Application Publication
(10) Pub. No.: US 2007/0109929 A1
(43) Pub. Date: May 17, 2007

(54) Differential phase detector

(75) Inventors: Pierluigi Lo Muzio, Feldkirchen (DE); Marten Kabutz, Villingen-Schwenningen (DE); Heinrich Schemmann, Villingen-Schwenningen (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING, Boulogne-Billancourt (FR)

(21) Appl. No.: 10/577,266

(22) PCT Filed: Oct. 16, 2004
(86) PCT No.: PCT/EP04/11686

§ 371 Date: Apr. 26, 2006

(30) Foreign Application Priority Data
Oct. 30, 2003 (EP) 03024813.2
Nov. 13, 2003 (EP) 03025972.5

(51) Int. Cl. G11B 7/00

(52) U.S. Cl. 369/44.34; 370/366; 370/536

(57) ABSTRACT

The present invention relates to a full-digital implementation of a differential phase detector and to an interpolator for such a differential phase detector. According to the invention a differential phase detector for generating a tracking error signal from the digitized signals (A, B, C, D) of four photodetectors, having a multiplexer for time multiplexing the digitized signals (A, B, C, D), includes a demultiplexer/interpolator for synchronizing the samples from the time multiplexed digitized signals (A, B, C, D). The demultiplexer/interpolator favorably receives a four signal time multiplex and generates four channels at half the speed of the time multiplex.

The present invention generally relates to a differential phase detector. More precisely, the invention relates to a full-digital implementation of a differential phase detector and to an interpolator for such a differential phase detector, and to an apparatus for reading from and/or writing to recording media using such differential phase detector.

For playback of a digital versatile disk (DVD) the signals from four photodetectors A, B, C and D are recovered in the front-end of a player. These signals are used for the generation of a high frequency main beam summing signal (A+B+C+D), i.e. the data signal (HF), and for differential phase detection (DPD). For the detection of lands and pits on the track it is sufficient to use the data signal HF. Since the data signal is processed in the digital domain, it is digitized by a proper analog to digital converter (ADC) at high speed.

For correct tracking the servo controller, which generates the tracking error signal, needs the four individual signals A, B, C and D from the photodetectors. For the generation of the tracking error signal generally differential phase detection is adopted. This technique is based on the measurement of the phase difference between the signals A, B, C and D from the photodetectors. The phase difference is evaluated by considering the time difference between the edges of the signals.

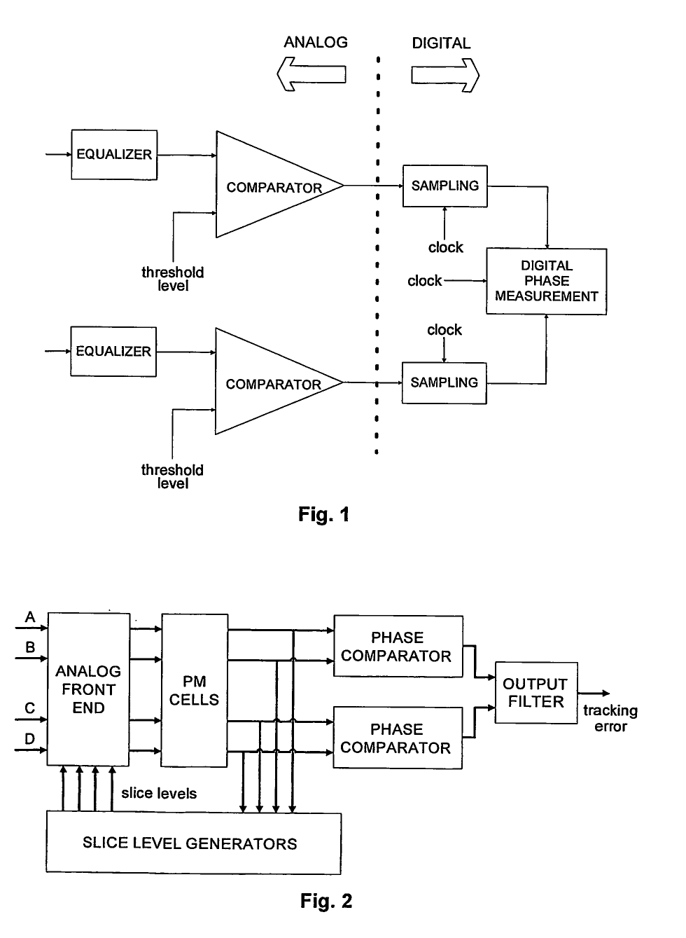

For differential phase detection several techniques can be adopted. If a mixed analog and digital method is adopted, after some analog processing usually comparators are sufficient for the construction of digital two-level signals. No additional analog to digital converters are needed for differential phase detection. Such an approach is depicted in FIG. 1. The digital part of the depicted circuit measures the clock cycles between the transitions of the sampled digital signals, which are obtained using a high-speed comparator for detecting the signal transitions above or below a certain threshold in the analog part. In practice the comparator can be considered as a 1-bit high speed analog to digital converter. The comparator might switch very easily due to noise. Therefore, it is a critical component and its hysteresis needs to be properly adjusted against the noise to avoid false transitions. Another limitation of this approach is that the clock frequency needs to be high for an accurate measurement of the time delay. A solution disclosed in U.S. Pat. No. 5,956,304, takes advantage of correlation for rejecting noise and increasing the resolution of the tracking error signal against the limited time resolution of the sampling clock.

A different solution disclosed in EP1 058 244, which is depicted in FIG. 2, considers the usage of a proper state machine for rejecting false transitions. However, this solution needs a special phase measurement unit (PM) for measuring the phase of the signal edges within the digital clock cycle (cf. PM cells in FIG. 2). Using the phase information, the resolution of the phase comparators becomes higher than the clock cycle. The analog front-end includes the equalizers and the comparators, which digitize the four signals using thresholds (slice levels) from slice level generators. The phase measurement cells sample the input two-level signals and evaluate the phase of the edges within the clock cycle. Phase comparators receive the digital information about the exact position of the edges from the phase measurement cells and use the mentioned state machine to measure the phase difference between couples of the input signals. An output filter interpolates the phase difference measurement to smooth the zero values, which are inserted in the clock cycles when there is no edge for the phase measurement. The slice level generators are digital units, which set the level of the comparators to suitable values, using the above mentioned edge information. Then the slice levels are converted to the analog domain in the analog front-end by means of proper digital to analog converters.

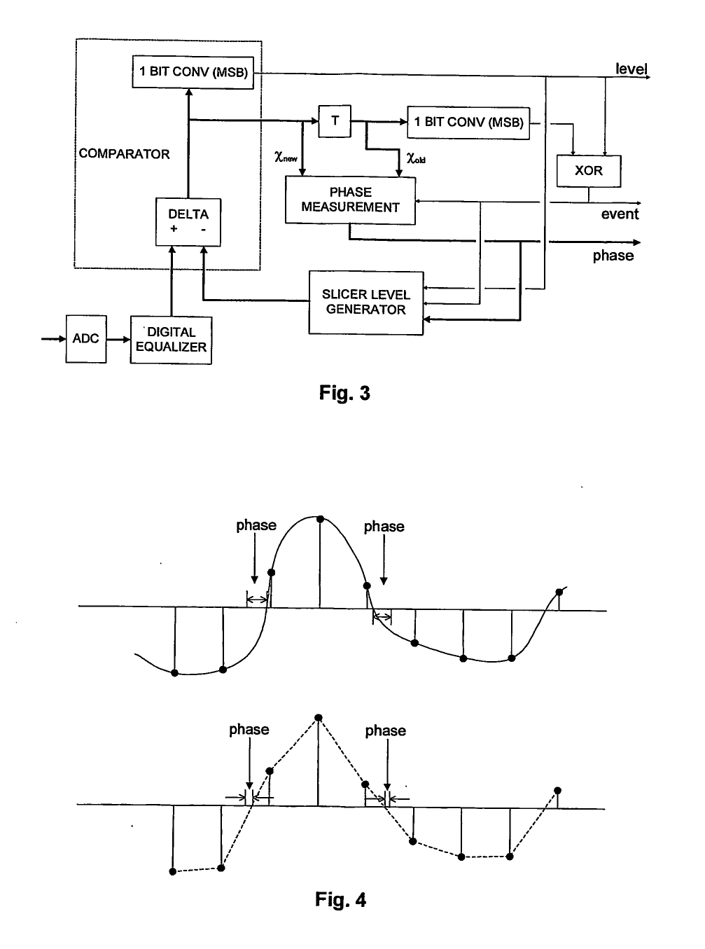

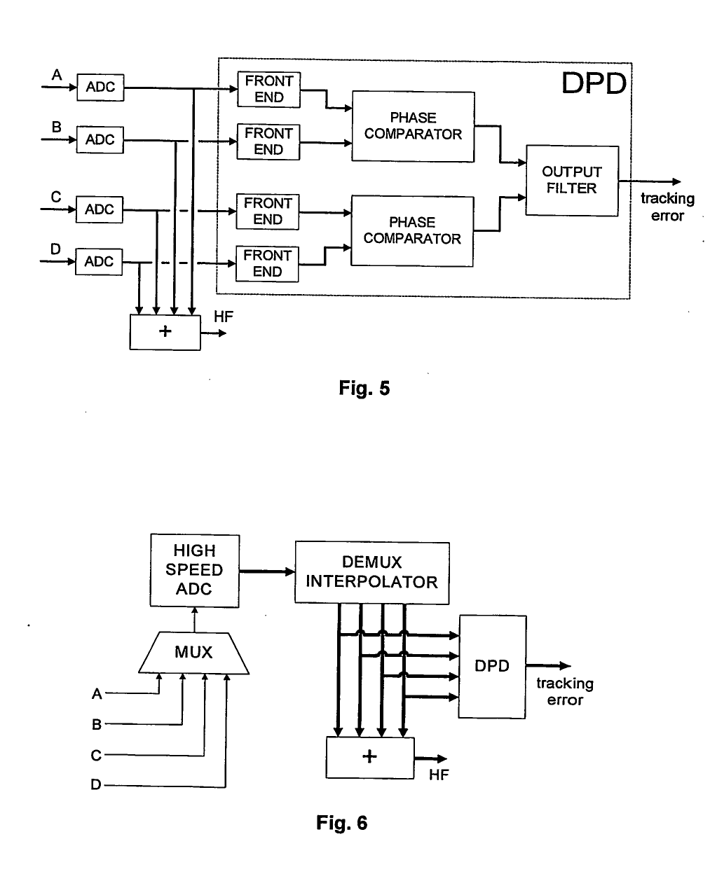

If on the other hand a full digital approach is implemented, the individual signals from the four detectors A, B, C and D are digitized and four analog to digital converters are needed. The abovementioned analog to digital converter for the data signal HF is no longer needed because the summing for the generation of the data signal HF can be implemented in the digital domain by summing the four digitized signals A, B, C, D. This solution is shown in FIG. 3 and FIG. 5.

It is an object of the invention to propose a further solution for a full-digital differential phase detection.

According to the invention, instead of using four analog to digital converters, a single analog to digital converter is used at a four times higher speed, as shown in FIG. 6. However, a problem arises: the analog to digital converter samples the four signals at different time instants. The resulting phase shift between the signals has severe consequences for the construction of the data signal HF and for the correct calculation of the phase difference for differential phase detection. In order to compensate for the different phase shift of the channels, an interpolation is necessary for generating new samples, which are synchronized for the four signals. These samples are required at half the sampling speed of the analog to digital converter.

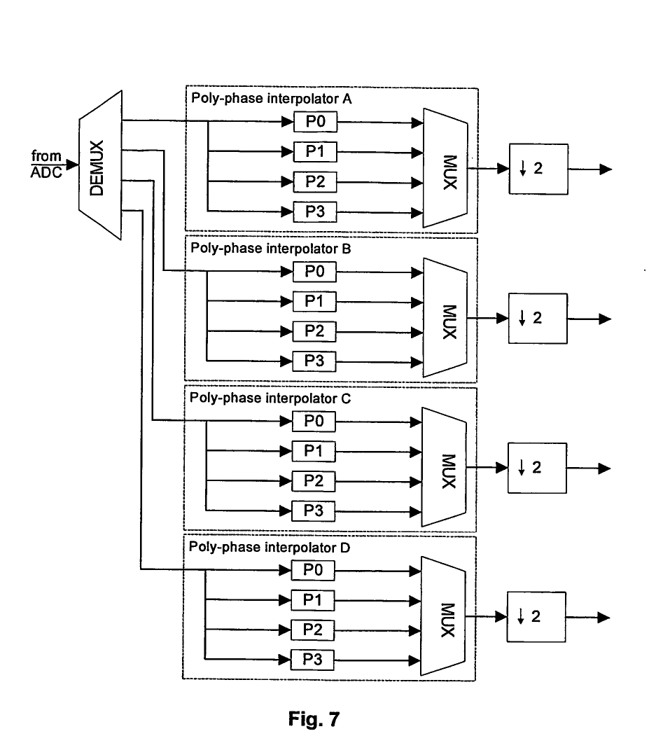

For reconstructing the synchronous samples, a trivial solution exists using for each signal the well-known poly-phase scheme, which implements the interpolation in an efficient way, up-sampling the signal to the speed of the analog to digital converter. This solution is depicted in FIG. 7. Moreover, considering the required sampling speed, the samples are decimated by a factor of two. It is evident that the interpolation calculates values which are rejected in the decimator. Therefore, a more efficient poly-phase scheme is desirable.

It is a further object of the invention to propose a new poly-phase architecture.

The poly-phase architecture according to the invention compensates the phase shift of a multiplexed source with N channels when the output decimation factor is an integer divider of N. This new architecture is universally valid and solves this problem with maximum efficiency.

In an exemplary embodiment the architecture is applied to the case of DVD playback, where four signals are generated and a decimation of the output is needed.

For a better understanding of the invention, an exemplary embodiment is specified in the following description with reference to the figures. It is understood that the invention is not limited to this exemplary embodiment and that specified features can also expediently be combined and/or modified without departing from the scope of the present invention. In the figures:

FIG. 1 shows a mixed analog and digital method for differential phase detection;

FIG. 2 shows a further mixed analog and digital method for differential phase detection;

FIG. 3 depicts an analog to digital converter and a digital front-end for differential phase detection for one channel;

FIG. 4 shows a comparison of the distortion caused by linear interpolation and by ideal interpolation;

FIG. 5 depicts a full-digital implementation of a differential phase detector and data signal generation;

FIG. 6 shows a full-digital implementation of a differential phase detector and data signal generation using a multiplexer;

FIG. 7 shows a three-step poly-phase implementation;

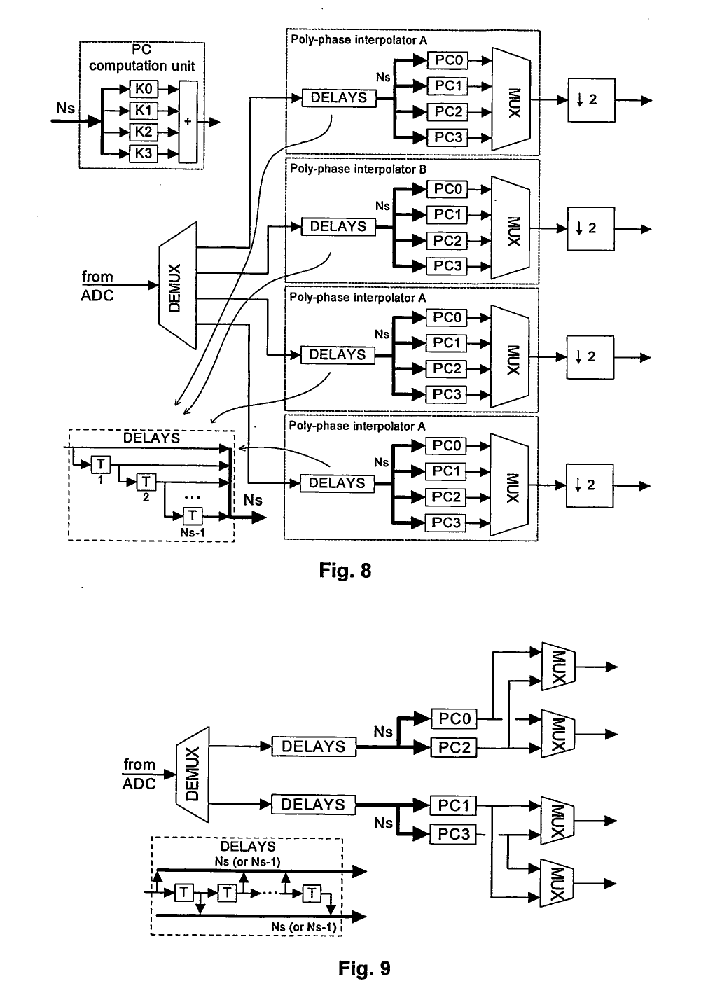

FIG. 8 depicts a three-step poly-phase implementation with reduced memory requirements;

FIG. 9 shows a poly-phase scheme according to the invention for phase compensation of a multiplexed source with four channels;

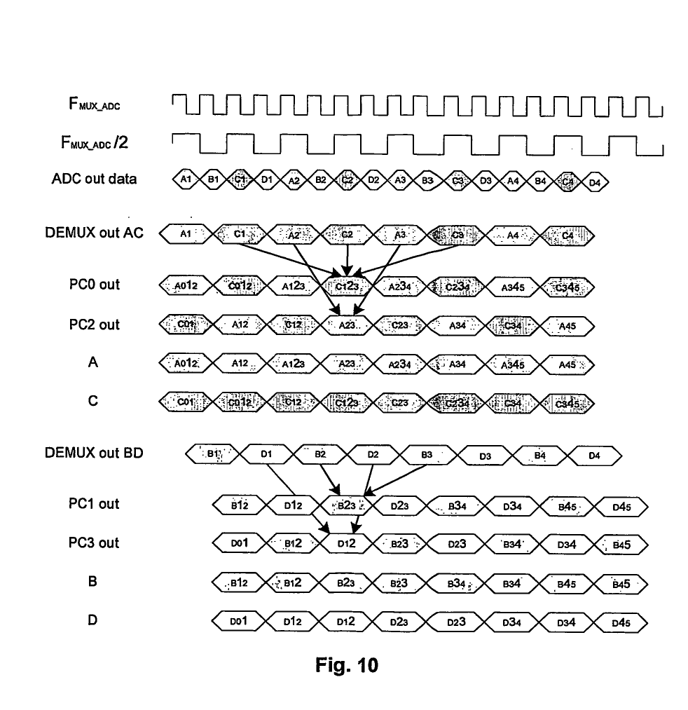

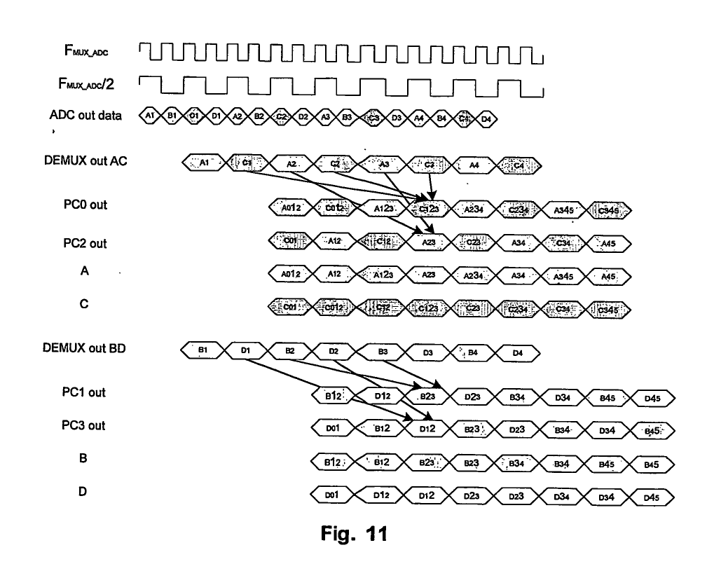

FIG. 10 depicts a timing diagram for ideal interpolation neglecting processing delays;

FIG. 11 depicts a timing diagram for interpolation taking into account processing delays;

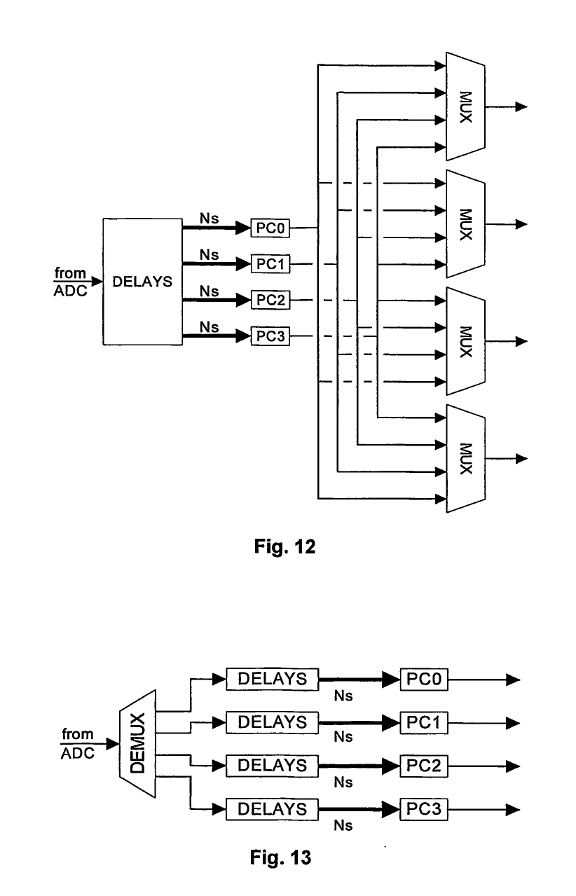

FIG. 12 shows a poly-phase scheme for four channels and a decimation factor of one;

FIG. 13 shows a poly-phase scheme for four channels and a decimation factor of four; and

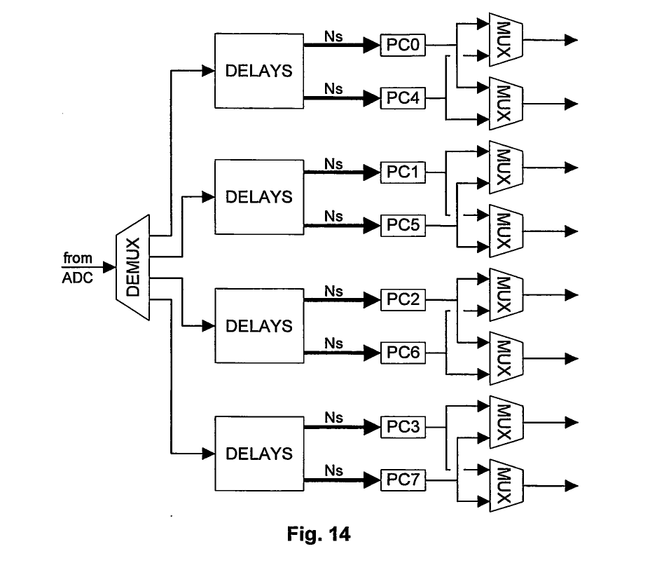

FIG. 14 shows a poly-phase scheme for eight channels and a decimation factor of four.

For differential phase detection the four signals A, B, C, D are digitized and also the signal edges are measured in the digital domain, which allows to avoid the analog comparators. The digital comparators are very simple because it is sufficient to extract the sign bit at the output of the difference between the two input signals. They receive the digital levels directly from the slicer level generators, without the need for digital to analog converters. The front-end of the differential phase detector is full digital. It includes the comparators, the slice level generator and the phase measurement. Such a digital front-end for one channel is shown in FIG. 3.

The time resolution is increased above the sampling clock by using the full amplitude of adjacent samples for calculating the exact time of the transition. The phase is measured only when the signal changes the sign. An XOR finds the edges of the input signal, a resulting enable signal initiates the phase calculation.

A first order approximation for the phase calculation is:

$$phase = \frac{{x}_{old} + {x}_{new}}{{x}_{old} - {x}_{new}} \cdot \frac{{N}_{ph}}{2}$$

where χ_{new} is the value of the signal after zero crossing, χ_{old} is the value of the signal before zero crossing and Nₚₕ is the number of phase levels within the clock cycle. The above phase calculation implies a linear interpolation as depicted in FIG. 4.

The linear interpolation is not an ideal interpolation, as it generates a linear distortion of the interpolated signal. This distortion is equivalent to an attenuation of the high frequency part of the signal spectrum. However, this distortion can be compensated by the equalizer by boosting high frequencies.

For the differential phase detector, which is shown in FIG. 5, the above described front-end is used four times in parallel, one front-end for each signal from the detectors. The data signal HF is generated using the same analog to digital converters that are used for the differential phase detector. The four signals A, B, C, D are then added in the digital domain.

Considering the availability of very high speed analog to digital converters, instead of four analog to digital converters at a sampling speed of F_{ADC}, a single analog to digital converter at a four times higher sampling speed (F_{MUX}_{_{—}}_{ADC}=4×F_{ADC}) might be used, multiplexing the four signals in the analog domain before the analog to digital converter. This approach is depicted in FIG. 6. Since the analog to digital converter samples the four signals at different time instants, the resulting phase shift has to be compensated. This is achieved by interpolating the four signals. Otherwise an unacceptable error is added before the phase measurement and the generation of the data signal HF.

For the above approach a new block is needed, the demux/interpolator. The block has the following functions:
separating the four signals,
compensating the phase shift of the sampling clock by interpolating the signal at higher speed, and
adapting the output sampling speed F_{OUT} to the sampling speed which is required by the differential phase detector and for the following processing of the data signal HF.

At the input of the differential phase detector it is favorable to have a high sampling speed, otherwise it becomes more difficult to compensate for the distortion caused by the linear interpolation. Also for the generation of the data signal HF it is advantageous to have a high sampling rate. Generally a sampling speed equal to half the sampling rate of the analog to digital converter is sufficient:

$${F}_{OUT} = \frac{{F}_{MUX\_ADC}}{2}$$

Consequently, the samples at the output of the interpolator are required at half the sampling speed of the analog to digital converter. In order to produce the synchronized output samples, the demux/interpolator applies the three mentioned functions in three steps: demultiplexing by four, interpolating by four, downsampling by two.

An implementation of the demux/interpolator has to provide means for performing the above mentioned three steps. The demux/interpolator shown in FIG. 7, therefore, includes:
a demultiplexer for the separation into four signals at a lower speed (F_{MUX}_{_{—}}_{ADC}/4),
four equal interpolators running at F_{MUX}_{_{—}}_{ADC}, one for each signal, for upsampling the four signals to a four times higher speed (F_{MUX}_{_{—}}_{ADC}) using the well-known poly-phase scheme for the interpolation,
four decimators for downsampling the signal to half the speed (F_{MUX}_{_{—}}_{ADC}/2) without any filtering, because the interpolation filter of the previous stage is sufficient for avoiding aliasing.

In FIG. 7, P0, P1, P2, P3 are the sub-filters of each poly-phase interpolator. These sub-filters are decimated versions of the prototype filter P for the rejection of periodic repetitions of the initial spectrum.
P0(n)=P(4·n),
P0(n)=P(4·n+1),
P0(n)=P(4·n+2),
P0(n)=P(4·n+3).
for n=1, . . . , Ns, where Ns is the maximum number of taps of each sub-filter. The internal delays of the sub-filters in the poly-phase interpolators can be strung together, thus forming a single set of delays. In this way an equivalent scheme with a lower number of delays can be implemented, which is depicted in FIG. 8. The blocks PC0, PC1, PC2, PC3 (PC denoting poly-phase computation) include only the computing function of the abovementioned sub-filters. The delays are transferred from the sub-filters into a single delay block, which at its output provides the Ns delayed versions of the input signals, where Ns is the maximum number of taps of each sub-filter. These Ns signals are fed to the input of the computation unit of each sub-filter. The computation units include the multipliers for the coefficients of the sub-filters as well as the summing function. They run at a lower speed (F_{MUX}_{_{—}}_{ADC}/4), because their output is used only one over four times by the multiplexers, which run at full speed (F_{MUX}_{_{—}}_{ADC}).

It is evident that the interpolator calculates values which are rejected in the decimator. Therefore, a more efficient poly-phase scheme is desirable. Such a poly-phase architecture, which compensates the phase shift of the four channels, is shown in FIG. 9. According to the invention, the architecture merges the demux, the interpolation filter and the decimator, thereby avoiding the calculation of samples which are discarded in the decimator. The scheme runs at the speed of the four output signals and exploits the usage of the poly-phase paths in time-multiplex for couples of channels, which avoids the replication of the poly-phase paths. Each poly-phase path runs at the speed of the output signals (F_{MUX}_{_{—}}_{ADC}/2). Each delay block merges a couple of the previous blocks, the outputs are interleaved; all of them have double length (2·Ns) and run at double speed (F_{MUX}_{_{—}}_{ADC}/2). One advantage of this architecture is that fewer resources are used. In fact the number of computation units (PC) is reduced by a factor of four in comparison with the previous architecture of FIG. 8. There are two reasons which explain the factor four in comparison with the known architecture:
the computation units are used at double speed, and
the computation units do not calculate that half of the values which is rejected by the sub-sampling.

The first point could be also obtained using other schemes, it yields a first factor of two. The second point is more important and characterizes the efficiency of this scheme, yielding a further factor of two. The full reduction factor consequently is four.

In order to explain this new scheme it is useful to consider the timing waveforms shown in FIG. 10. In this figure the delay for the processing is neglected, wherefore the calculated samples are allocated in the time location where they should be needed.

The samples coming from the analog to digital converter (ADC out data) arrive at the F_{MUX}_{_{—}}_{ADC} sample rate. Instead of a demultiplexer, which separates the four signals, a smaller demultiplexer is used. The data coming from two of the photodetectors (A and C data) are still combined at the output of the multiplexer (DEMUX out AC). The same holds for the data coming from the two remaining photodetectors (B and D data) (DEMUX out BD). Assuming that there is no delay, an ideal demultiplexer would allocate the output samples (DEMUX out AC and DEMUX out BD) exactly where they were originally. New output values for the four channels are needed at the speed of F_{MUX}_{_{—}}_{ADC}/2. These values are calculated at the time instants of A1, C1, A2, C2, . . . For example, assuming a nine taps prototype filter, which generates three taps for the P0 sub-filter and two taps for the other sub-filters, at the time instant of C2:
the poly-phase computation unit PC0 calculates C123. The bold 2 represents the higher value of the middle coefficient, which corresponds to the input value C2,
the poly-phase computation unit PC2 calculates A23.
the poly-phase computation unit PC1 calculates B23. The bold 2 represents the higher value of the coefficient corresponding to the input value B2, which is closer to the time instant where B23 is needed,
the poly-phase computation unit PC3 calculates D12. The bold 2 represents the higher value of the coefficient corresponding to the input value D2, which is closer to the time instant where D12 is needed. All poly-phase computation units need interleaved samples from the delays to extract only the samples of one channel upon a time from the time multiplex.

The four calculated values are passed through the four output multiplexers. In the following time instant, which corresponds to A3, the poly-phase computation unit PC0 is needed for the A channel and the poly-phase computation unit PC2 is needed for the C channel. The doubling of the computation units is avoided if the A and C channels are received at the input of the computation units in time multiplex. The same holds for B and D channels. Therefore, the input demultiplexer separates two signals and not four. Moreover, the calculation of interpolated values at time instants corresponding to D2 and B3 is not needed. In the architecture shown in FIG. 8 the interpolated values are calculated and rejected. In the architecture shown in FIG. 9 this unnecessary computation is avoided.

Of course, the ideal situation represented in FIG. 10, whose purpose is to show the proper interpolation, is not causal since it uses input values which are not yet available. A realistic situation is depicted in FIG. 11, where all signals are synchronized with the F_{MUX}_{_{—}}_{ADC}/2 clock. The two outputs of the demultiplexer are delayed and synchronized accordingly. The PC0out and PC2out are delayed by two additional clock cycles as C3 needs to be available for the computation of C123. An additional delay of one clock cycle is needed for PC0out and PC2out to guarantee that the output samples of A and C are synchronized with the values of B and D, as in the previous FIG. 10. All the above delays are included in the delays, which are represented in the block diagram shown in FIG. 9.

The above scheme is extendable to other applications where in general the number of channels in the multiplexed source is not four, but N, and the sub-sampling factor is not two, but D, and D is an integer divider of N. Two simple cases with D=1 and D=N are demonstrated in FIG. 12 and FIG. 13, assuming that N=4. A further case with N=8 and D=4 is presented in FIG. 14. The conclusions are that:
the number of poly-phase computation units is always equal to N,
the input demultiplexer separates S signals with S=D; each of these signals has the same sample speed as the requested output speed, according to the D sub-sampling factor,
the number of the delays blocks is S,
the number of output multiplexers is equal to the number of the channels in the input time multiplex; each of the multiplexers selects a certain number I of inputs with I=N/D (of course the multiplexers are not needed when N=D).

The above considerations are sufficient to design a demux/interpolator for any case of N and D.

1. Combined demultiplexer and interpolator, wherein it receives a time multiplex of N signals and in that it generates N channels at 1/D times the speed of the time multiplex, where D is an integer divider of N.

2. Combined demultiplexer and interpolator according to claim 1, wherein it receives a four signal time multiplex and in that it generates four channels at half the speed of the time multiplex.

3. Differential phase detector for generating a tracking error signal from the digitized signals of four photodetectors, including a multiplexer for time multiplexing the digitized signals, wherein it includes a demultiplexer/interpolator for synchronizing the samples from the time multiplexed digitized signals.

4. Differential phase detector according to claim 3, wherein it includes summing means for summing the synchronized samples of the demultiplexer/interpolator to generate a data signal (HF).

5. Differential phase detector according to claim 3, further including means for compensating an attenuation of high signal frequencies caused by the interpolation.

6. Differential phase detector according to claim 3, wherein the demultiplexer/interpolator receives a time multiplex of N signals and in that it generates N channels at 1/D times the speed of the time multiplex, where D is an integer divider of N.

7. Differential phase detector according to claim 6, wherein the demultiplexer/interpolator receives a four signal time multiplex and in that it generates four channels at half the speed of the time multiplex.

8. Method for combined demultiplexing and interpolating, including the steps of:
receiving a time multiplex of N signals, and
generating N channels at 1/D times the speed of the time multiplex, where D is an integer divider of N.

9. Method for differential phase detection, including the steps of:
digitizing the output signals of four photodetectors,
time multiplexing the digitized signals,
synchronizing the samples from the time multiplexed digitized signals with a demultiplexer/interpolator, and
generating a tracking error signal from the digitized and synchronized signals.

10. Apparatus for reading from and/or writing to optical recording media, wherein it includes a differential phase detector according to claim 3.
